(19) United States
(12) Patent Application Publication
(10) Pub. No.: US 2016/0121709 A1
(43) Pub. Date: May 5, 2016

(54) IN-WHEEL DRIVE APPARATUS

(71) Applicant: Hyundai Mobis Co., Ltd., Seoul (KR)

(72) Inventor: Kyeong Ho SHIN, Yongin-si (KR)

(21) Appl. No.: 14/887,793

(22) Filed: Oct. 20, 2015

(30) Foreign Application Priority Data
Oct. 30, 2014 (KR) 10-2014-0149629

(51) Int. Cl. B60K 7/00; B60T 11/10; B60T 1/06

(52) U.S. Cl. CPC B60K 7/0007; B60T 1/067; B60T 11/10; B60K 2007/0092

(57) ABSTRACT

An in-wheel drive apparatus includes a motor housing, a rotor, a rotor shaft, and a hub. The motor housing is supported in a wheel of the in-wheel drive apparatus. The rotor is rotatably supported in the motor housing. The rotor shaft protrudes from the rotor and is configured to rotate with the rotor. The hub is rotatably coupled to the motor housing. The hub is coupled to the rotor shaft. A rotational force of the rotor rotates the wheel via the hub.

### CROSS-REFERENCE TO RELATED APPLICATION

This application claims priority from and the benefit of Korean Patent Application No. 10-2014-0149629, filed Oct. 30, 2014, which is hereby incorporated by reference for all purposes as if fully set forth herein.

### BACKGROUND

1. Field

Exemplary embodiments relate to an in-wheel drive apparatus. More particularly, exemplary embodiments relate to an in-wheel drive apparatus including a motor installed in a wheel to drive the wheel.

2. Discussion

As fossil fuels are being exhausted, an electric vehicle, which drives a motor using electrical energy stored in a battery, is being developed to substitute for a vehicle using fossil fuels, such as gasoline and diesel fuel, as a source of energy. Electric vehicle may be classified into pure electric vehicles, which drive a motor using only electrical energy stored in a charged battery; solar cell vehicles, which drive a motor using energy from photocells; fuel cell vehicles, which drive a motor using energy derived from a fuel cell that uses, for instance, hydrogen fuel; and hybrid electric vehicles, which use both a conventional engine driven via the combustion of fossil fuels and an electric motor driven using electricity.

An in-wheel motor may be used in a vehicle, such as an electric vehicle, to transmit power directly to the rotation of a wheel using an electric motor disposed in a rim of the wheel. The electric motor uses electricity as a power source. Conventional gasoline or diesel fuel vehicles rotate their wheels via power transmission through an engine, a transmission, and a drive shaft. In this manner, an in-wheel motor may enable drive devices and power transmission devices, such as an engine, a transmission, a differential gear, etc., to be omitted. The elimination of these drive and power transmission devices may enable reductions in vehicle weight and energy losses during a power transmission process.

Conventional in-wheel motors typically include a decelerator for amplifying driving power of the motor and a drum brake apparatus for braking the wheel. The decelerator and the drum brake apparatus are usually sequentially arranged beside the motor in a straight line that runs through a center of the wheel. In this manner, the motor is not completely inserted into the wheel and a horizontal width of the in-wheel drive apparatus becomes relatively large. As such, a space for installing a parking brake is insufficient.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a compact in-wheel drive apparatus.

Additional aspects will be set forth in the detailed description which follows, and, in part, will be apparent from the disclosure, or may be learned by practice of the inventive concept.

According to one or more exemplary embodiments, an in-wheel drive apparatus includes a motor housing, a rotor, a rotor shaft, and a hub. The motor housing is supported in a wheel of the in-wheel drive apparatus. The rotor is rotatably supported in the motor housing. The rotor shaft protrudes from the rotor and is configured to rotate with the rotor. The hub is rotatably coupled to the motor housing. The hub is coupled to the rotor shaft. A rotational force of the rotor rotates the wheel via the hub.

According to one or more exemplary embodiments, an in-wheel drive apparatus includes a wheel, a hub, and a motor assembly. The hub is coupled to an inner surface of the wheel. The motor assembly is supported entirely within a cavity of the wheel via the hub. The motor assembly is configured to cause the wheel to rotate via the hub.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a view of an in-wheel drive apparatus, according to one or more exemplary embodiments.

FIG. 2 is a cross-sectional view of the in-wheel drive apparatus of FIG. 1 taken along sectional line II-II, according to one or more exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of components, layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms “first,” “second,” etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” “inside,” “outside,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. To this end, spatially relative terms are intended to encompass different viewpoints of one component with respect to another. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

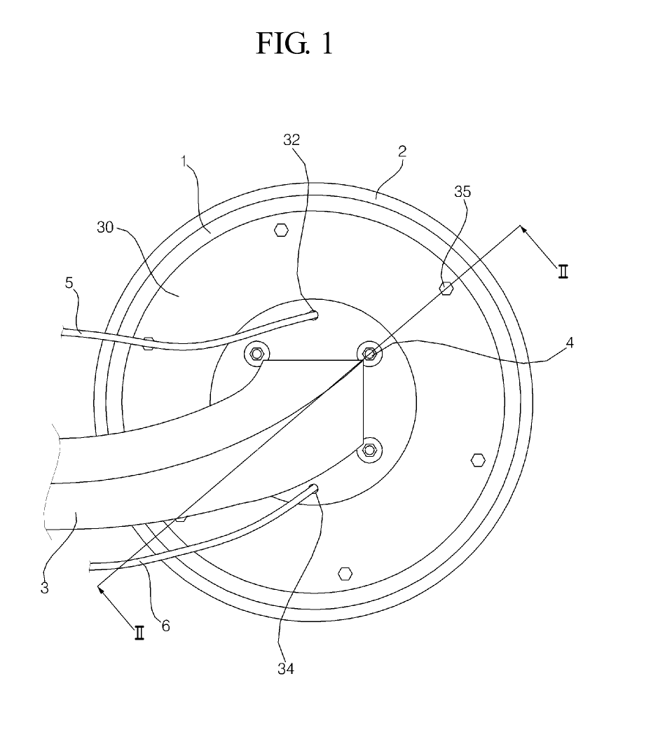

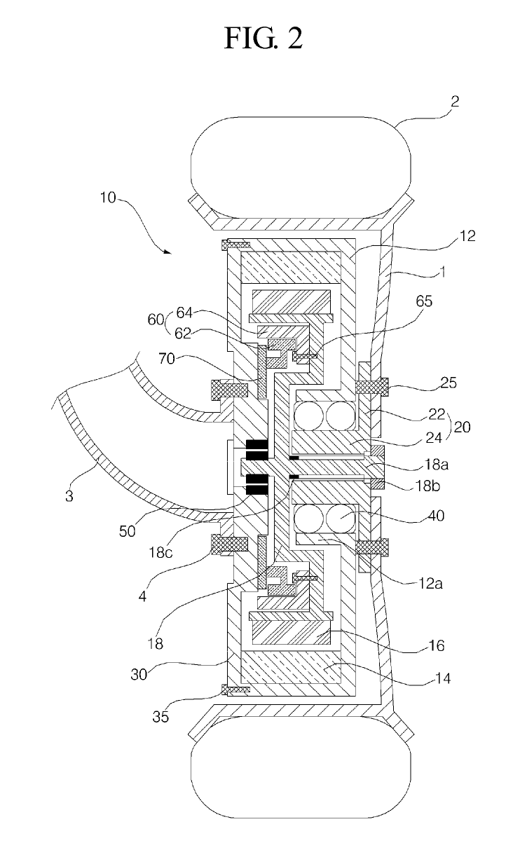

FIG. 1 is a view of an in-wheel drive apparatus, according to one or more exemplary embodiments. FIG. 2 is a cross-sectional view of the in-wheel apparatus of FIG. 1 taken along sectional line II-II.

Referring to FIGS. 1 and 2, the in-wheel drive apparatus includes an in-wheel motor 10 disposed in a wheel 1. A tire 2 is mounted on an outer circumferential surface of a rim of the wheel 1. A hub 20 is coupled inside the wheel 1 via fastening member 25, such as a bolt. It is contemplated, however, that any suitable coupling mechanism may be used as the fastening member 25. The hub 20 includes a wheel coupling portion 22 coupled to a central portion inside the wheel 1 via the fastening member 25, and a motor housing coupling portion 24 protruding towards an inside of a vehicle (not shown). For instance, motor housing coupling portion 24 may be bent at 90 degrees at a center of the wheel coupling portion 22 to protrude toward the inside of the vehicle. A hollow space is formed at a center of the motor housing coupling portion 24. Further, the motor housing coupling portion 24 is disposed along an imaginary straight line extending horizontally through a center of the wheel 1.

A portion of the rim of the wheel 1 that is directed toward the inside of the vehicle is opened. The in-wheel motor 10 is inserted into the wheel 1 through the opened portion of the rim. The in-wheel motor 10 is completely disposed within the wheel 1. As seen in FIG. 2, the in-wheel motor 10 includes a motor housing 12 completely disposed in the wheel 1, a stator 14 fixedly coupled inside the motor housing 12, a rotor core 16 disposed in the motor housing 12 and spaced apart from the stator 14, and a rotor 18 having an outer circumferential surface coupled to an inner circumferential surface of the rotor core 16. The stator 14 is rotated when an electric current is applied to the in-wheel motor 10, and the rotor 18 is rotated together with the rotor core 16 when the rotor core 16 is rotated. A central portion of a front surface of the motor housing 12, which is directed toward the outside of the vehicle, is recessed rearward to form a mounting portion 12a. That is, the mounting portion 12a is a void in the motor housing 12 configured to accept hub 20. In this manner, the motor housing coupling portion 24 of the hub 20 is inserted into the mounting portion 12a.

A rear side of the motor housing 12, which is directed toward the inside of the vehicle, is opened. A back plate 30 is coupled at the opened rear side of the motor housing 12 via a fastening member 35. As seen in FIGS. 1 and 2, a bolt is used as the fastening member 35; however, any suitable coupling means may be utilized in association with exemplary embodiments disclosed herein. When the back plate 30 is coupled to the motor housing 12, the back plate 30 covers the opened rear side of the motor housing 12. The motor housing coupling portion 24 of the hub 20 is inserted into the mounting portion 12a of the motor housing 12, and is rotatably coupled to the mounting portion 12a of the motor housing 12. The motor housing coupling portion 24 may be rotatably coupled to the mounting portion 12a via a bearing 40. As seen in FIG. 2, a double bearing is provided as the bearing 40, however, any suitable bearing or friction reducing assembly may be utilized in association with exemplary embodiments disclosed herein.

A rotor shaft 18a protrudes through a center of the rotor 18. When the rotor 18 is rotated, the rotor shaft 18a is rotated together with the rotor 18. The rotor shaft 18a may be formed directly on the rotor 18, or may be formed as a member separate from the rotor 18 and fixed to the rotor 18 via a key. When the rotor shaft 18a is formed directly as part of a center of the rotor 18, the rotor shaft 18a protrudes from both sides of the rotor 18. When the rotor shaft 18a is formed as a member separate from the rotor 18, the rotor shaft 18a penetrates a central portion (e.g., through hole) of the rotor 18, such that both ends of the rotor shaft 18a protrude from the rotor 18. One end of the rotor shaft 18a, which is directed toward the front side of the wheel 1, penetrates the central portion of the mounting portion 12a of the motor housing 12 and protrudes toward the outside of the motor housing 12. In this manner, the one end of the rotor shaft 18a penetrates the motor housing coupling portion 24, which is at the center of the hub 20 that is inserted into the mounting portion 12a. The one end of the rotor shaft 18a protrudes toward the outside of the hub 20 and is coupled to the hub 20 via a nut 18b or any other suitable coupling means.

Like the motor housing coupling portion 24 of the hub 20, the rotor shaft 18a is disposed along an imaginary straight line that horizontally runs through the center of the wheel 1. That is, the rotor shaft 18a, the center of the hub 20, and the center of the wheel 1 are disposed in a straight line, or, in other words, are concentrically aligned with one another along the same rotational axis about which wheel 1 rotates. An outer circumferential surface of the rotor shaft 18a, which penetrates the motor housing coupling portion 24, is fixed to an inner circumferential surface of the motor housing coupling portion 24. A seal 18c is disposed between the outer circumferential surface of the rotor shaft 18a and the inner circumferential surface of the motor housing coupling portion 24. The seal 18c seals a gap between the outer circumferential surface of the rotor shaft 18a and the inner circumferential surface of the motor housing coupling portion 24 to prevent (or at least reduce) foreign substances from entering the motor housing 12. The other end of the rotor shaft 18a, which is directed toward the inside of the vehicle, is rotatably coupled to a central portion of the back plate 30. A resolver 50 for detecting a position of the rotor shaft 18a is disposed in the central portion of the back plate 30.

An outer circumferential surface of the motor housing coupling portion 24 of the hub 20 is rotatably coupled to the mounting portion 12a of the motor housing 12 and supported by the motor housing 12. In addition, the inner circumferential surface of the motor housing coupling portion 24 of the hub 20 is coupled to the outer circumferential surface of the rotor shaft 18a. As described above, because the hub 20 is rotatably coupled to the motor housing 12, is supported by the motor housing 12, and is coupled to the rotor shaft 18a, the hub 20 is rotated together with the rotor 18 by rotational force of the rotor 18 when the rotor 18 is rotated. In this manner, the hub 20 may rotate the wheel 1 when the rotor 18 is rotated.

According one or more exemplary embodiments, a decelerator (which is typically utilized in a conventional in-wheel drive apparatus) for amplifying driving power of the in-wheel motor 10 is not installed between the in-wheel motor 10 and the hub 20. Instead, the rotor shaft 18a of the in-wheel motor 10 is directly coupled to the hub 20 and rotates the hub 20. As a result, the in-wheel motor 10 may be completely inserted into the rim of the wheel 1, such that the in-wheel drive apparatus is more compact than a conventional in-wheel drive apparatus. As a substitute for the decelerator, the rotor core 16, which has a larger diameter than a typical rotor core in a conventional in-wheel drive apparatus, is used to further amplify driving power.

A trailing arm 3 is coupled to an outer surface of the back plate 30 by means of a fastening member 4, such as a bolt; however, any suitable fastening device or means may be utilized in association with exemplary embodiments described herein. It is noted that a damper (not shown) is coupled to the trailing arm 3 in order to absorb vibration transmitted from a road surface to a vehicle body through the wheel 1. The damper is a component of a suspension system (not illustrated). The damper may have an upper end connected to the vehicle body and a lower end seated on and coupled to the trailing arm 3. It is also noted that a spring (not shown) may be installed on the damper, e.g., in a coilover assembly, or in a spring seat coupled to or formed as part of trailing arm 3.

A drum brake apparatus 60 for braking the wheel 1 is installed in the wheel 1. As seen in FIG. 2, the drum brake apparatus 60 is disposed in the motor housing 12 in order to reduce a horizontal width of the in-wheel drive apparatus. The drum brake apparatus 60 includes a brake shoe 62 disposed on the back plate 30 inside the motor housing 12, and a brake drum 64 coupled to the rotor 18 by means of a fastening member 65, such as a bolt; however, any suitable fastening device or means may be utilized in association with exemplary embodiments described herein. A hydraulic cylinder 70 is coupled to an inner surface of the back plate 30, which is a surface disposed in the motor housing 12. The hydraulic cylinder 70 is connected to the brake shoe 62, and supplies hydraulic fluid (e.g., hydraulic oil) to the brake shoe 62. When the hydraulic fluid is supplied to the brake shoe 62 from the hydraulic cylinder 70, the brake shoe 62 expands and comes into contact with the brake drum 64. That is, when the brake shoe 62 expands, the brake drum 64 causes friction with the brake shoe 62 to brake the rotor 18. It is noted that the brake shoe 62 may expand in a radial direction of rotor 18, e.g., perpendicular to a rotational axis of wheel 1.

A hole 32 is formed in the back plate 30. The hole 32 enables a hydraulic line 5 to supply hydraulic fluid to the hydraulic cylinder 70. The hydraulic line 5 is inserted into the hole 32 and connected to the hydraulic cylinder 70. In this manner, the hydraulic fluid flowing in the hydraulic line 5 is supplied to the hydraulic cylinder 70, stored in the hydraulic cylinder 70, and then supplied to the brake shoe 62 from the hydraulic cylinder 70. As a result, the brake shoe 62 expands by hydraulic pressure of the hydraulic fluid and comes into contact with the brake drum 64 to cause friction with the brake shoe 62.

A hole 34 is formed in the back plate 32. The hole 34 enables a cable 6 of a parking brake to interface with a caliper (not shown). That is, the cable 6 of the parking brake is inserted into the hole 34 and connected to the caliper, which is a mechanism for restricting the rotation of the rotor 18. In this manner, the caliper may be installed on the inner surface of the back plate 30, and a pad (not illustrated) may be installed on a surface of the rotor 18, which faces the caliper. When the cable 6 of the parking brake is pulled (or otherwise tensioned), a disc disposed on the caliper may press the pad to prevent the rotor 18 from being rotated, and, as a result, the wheel 1 may be prevented from being rotated.

An exemplary process of assembling the in-wheel drive apparatus will now be described with reference to FIGS. 1 and 2. It is noted, however, that the following process is merely illustrative and the sequence of the steps (or methodology described herein) may be altered so long as the coupling relationship between the various components of the in-wheel apparatus remain the same.

According to one or more exemplary embodiments, the stator 14 is coupled to an inner circumferential surface of the motor housing 12 by, for instance, shrink-fitting. Thereafter, the bearing 40 is fastened to the mounting portion 12a of the motor housing 12, and the motor housing coupling portion 24 of the hub 20 is inserted into the bearing 40. In this manner, the hub 20 may be rotatably coupled to the motor housing 12. The rotor core 16 may then be coupled to the outer circumferential surface of the rotor 18 by, for example, shrink-fitting. Thereafter, the brake drum 64 is coupled to the rotor 18 via the fastening member 65.

After assembly of the brake drum 64 to the rotor 18, the hydraulic cylinder 70 is coupled to the back plate 30, such that the hydraulic cylinder 70 and the brake shoe 62 are disposed on the back plate 30. The resolver 50 is then fastened to a central portion of the back plate 30. The hydraulic line 5 is then inserted into the hole 32 formed in the back plate 30, and coupled to the hydraulic cylinder 70. Thereafter, the cable 6 of the parking brake is inserted into the hole 34 formed in the back plate 30 and coupled to the mechanism for restricting the rotation of the rotor 18.

With a front end of the rotor shaft 18a being inserted into the motor housing coupling portion 24 of the hub 20 and a rear end of the rotor shaft 18a being inserted into the resolver 50, the back plate 30 is fastened to the motor housing 12 via the fastening member 35. The nut 18b is fastened to the front end of the rotor shaft 18a, such that the front end of the rotor shaft 18a is fixed to the hub 20. Thereafter, the trailing arm 3 is fastened to the back plate 30 via the fastening member 4. The wheel coupling portion 22 of the hub 20 is fastened to the wheel 1 via the fastening member 25.

Exemplary operation of the in-wheel drive apparatus will now be described with reference to FIGS. 1 and 2.

In association with rotating the wheel 1, an electric current may be applied to an inverter of the in-wheel motor 10. As such, the rotor core 16 may be rotated by a magnetic field generated between the stator 14 and the rotor core 16. In this manner, the rotor 18 coupled to the rotor core 16 is caused to be rotated together with the rotor core 16. Furthermore, because the rotor shaft 18a and the hub 20 are rotated together with the rotor 18, the wheel 1 is also caused to be rotated.

In association with braking the wheel 1, both frictional and magnetic force may be utilized to slow and break the wheel 1. That is, a braking force generated by friction between the brake drum 64 and the brake shoe 62 may be utilized, as well as a braking force generated by controlling the inverter of the in-wheel motor 10. For instance, when hydraulic fluid is supplied into the hydraulic cylinder 70 through the hydraulic line 5, the brake shoe 62 expands and comes into contact with the brake drum 64. The contact between the brake shoe 62 and the brake drum causes friction to, thereby, brake the rotor 18. Further, when braking force is generated in the rotor core 16 by controlling the inverter of the in-wheel motor 10, a magnetic field may be generated between the stator 14 and the rotor core 16 to cause rotational force in a direction opposite to a direction of rotation of the wheel 1. In this manner, the rotor 18 is braked, which, in turn, causes the wheel 1 to be braked.

According to one or more exemplary embodiments, the hub 20 may be rotatably coupled to the motor housing 12 to reduce a horizontal width of the in-wheel drive apparatus. To this end, the hub 20 may be coupled directly to the rotor shaft 18a of the in-wheel motor 10, which may further reduce the horizontal width of the in-wheel drive apparatus. Moreover, the drum brake apparatus 60 may be disposed in the motor housing 12, which also serves to reduce the horizontal width of the in-wheel drive apparatus. The horizontal width of the in-wheel apparatus may also be reduced via installation of the parking brake mechanism in the motor housing 12.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An in-wheel drive apparatus comprising:
a motor housing supported in a wheel;
a rotor rotatably supported in the motor housing;
a rotor shaft protruding from the rotor, the rotor shaft being configured to rotate with the rotor; and
a hub rotatably coupled to the motor housing, the hub being coupled to the rotor shaft,
wherein a rotational force of the rotor rotates the wheel via the hub.

2. The in-wheel drive apparatus of claim 1, further comprising:
a bearing disposed between the hub and the motor housing,
wherein the bearing reduces rotational friction between the hub and the motor housing.

3. The in-wheel drive apparatus of claim 1, wherein the rotor shaft extends through a central portion of the hub.

4. The in-wheel drive apparatus of claim 1, wherein the motor housing is disposed completely within the wheel.

5. The in-wheel drive apparatus of claim 1, wherein:
a central portion of the motor housing is recessed to form a mounting portion configured to accept a portion of the hub therein; and
the hub is rotatably coupled to the mounting portion.

6. The in-wheel drive apparatus of claim 5, wherein the hub comprises:
a wheel coupling portion coupled to an inner surface of the wheel; and
a motor housing coupling portion protruding from the wheel coupling portion, the motor housing coupling portion being disposed in the mounting portion of the wheel and rotatably coupled to the mounting portion.

7. The in-wheel drive apparatus of claim 1, further comprising:
a back plate,
wherein:
the hub is rotatably coupled to the motor housing at a first side of the motor housing;
a second side of the motor housing is opened to form a cavity in the motor housing, the second side of the motor housing opposing the first side of the motor housing; and
the back plate is coupled to the second side of motor housing to cover the opening to the cavity.

8. The in-wheel drive apparatus of claim 7, wherein the back plate is configured to interface with a trailing arm of a suspension system of a vehicle.

9. The in-wheel drive apparatus of claim 7, further comprising:
a brake shoe supported in the motor housing; and
a brake drum coupled to the rotor, the brake drum being spaced apart from the brake shoe,
wherein displacement of the brake shoe is configured to cause frictional force with the brake drum.

10. The in-wheel drive apparatus of claim 9, further comprising:
a hydraulic cylinder supported in the motor housing, the hydraulic cylinder being configured to provide hydraulic pressure to cause the displacement of the brake shoe.

11. The in-wheel drive apparatus of claim 10, wherein:
the back plate comprises a hole; and
a hydraulic line passes through the hole to interface with the hydraulic cylinder, the hydraulic line being configured to provide hydraulic fluid to the hydraulic cylinder.

12. The in-wheel drive apparatus of claim 7, wherein:
the back plate comprises a hole;
a parking brake cable passes through the hole.

13. An in-wheel drive apparatus, comprising:
a wheel;
a hub coupled to an inner surface of the wheel; and
a motor assembly supported entirely within a cavity of the wheel via the hub,
wherein the motor assembly is configured to cause the wheel to rotate via the hub.

14. The in-wheel drive apparatus of claim 13, wherein the motor assembly comprises:
a housing, the hub being rotatably coupled to the housing; and
a rotor coupled to the hub, the rotor being supported within the housing.

15. The in-wheel drive apparatus of claim 14, wherein:
the motor assembly further comprises:
a stator supported via the housing; and
a rotor core supported via the rotor;
a first end of a shaft of the rotor is coupled to the hub.

16. The in-wheel drive apparatus of claim 15, further comprising:
a back plate,
wherein the housing comprises:
a first opening configured to rotatably support a portion of the hub; and
a second opening opposing the first opening, the back plate covering the second opening, and
wherein a second end of the shaft of the rotor extends through a hole in the back plate.

17. The in-wheel drive apparatus of claim 16, wherein
the motor assembly further comprises:
a brake shoe supported in the housing; and
a brake drum supported in the housing; and
displacement of the brake shoe is configured to cause friction between the brake shoe and the brake drum to mechanically brake the in-wheel drive apparatus.

18. The in-wheel drive apparatus of claim 17, further comprising:
a hydraulic cylinder interfacing with the brake shoe,
wherein the hydraulic cylinder is configured to cause the displacement of the brake shoe.

19. The in-wheel drive apparatus of claim 18, wherein the hydraulic cylinder is supported within the housing.

20. The in-wheel drive apparatus of claim 16, wherein the back plate is configured to interface with a trailing arm of a suspension system.
